(19) United States
(12) Patent Application Publication
(10) Pub. No.: US 2020/0234219 A1
(43) Pub. Date: Jul. 23, 2020

(54) DISPOSITION OPTIMIZATION SYSTEM AND DISPOSITION OPTIMIZING METHOD

(71) Applicant: HITACHI, LTD., Tokyo (JP)

(72) Inventors: Hiroyuki NAMBA, Tokyo (JP); Atsushi TOMODA, Tokyo (JP); Hiromitsu NAKAGAWA, Tokyo (JP); Masashi EGI, Tokyo (JP)

(73) Assignee: HITACHI, LTD., Tokyo (JP)

(21) Appl. No.: 16/554,107

(22) Filed: Aug. 28, 2019

(30) Foreign Application Priority Data
Jan. 23, 2019 (JP) 2019-009020

(51) Int. Cl. G06Q 10/06; G06Q 10/08; G06Q 10/10

(52) U.S. Cl. CPC G06Q 10/06398; G06Q 10/087; G06Q 10/06316; G06Q 10/0633; G06Q 10/1091

(57) ABSTRACT

A DB server 2 stores work achievement table 210 indicating a disposition target related to a work, an actual disposition place where the disposition target is disposed, and actual work time taken for the work for each work and location information 220 indicating a plurality of disposition places where the disposition targets can be disposed. A control portion 330 acquires a mutual action search policy including a plurality of mutual action emergence patterns indicating a relation between the two disposition places influencing the work time taken for the work. A generating portion (an item combination extraction portion 350, a mutual action set search portion 360, and a disposition change optimization portion 370) generates a disposition plan indicating a plan of disposition place where the disposition target is disposed on the basis of the work achievement information, the location information, and the mutual action search policy.

### BACKGROUND

This disclosure relates to a disposition optimization system and a disposition optimizing method.

Improvement of operational efficiency by appropriately disposing items and staff in a warehouse or in a plant has been a problem. For example, optimization of disposition of the items is in demand in the physical distribution business in order to improve efficiency of a shipment work of items in the warehouse.

In response to the aforementioned problem, Japanese Patent Laid-Open No. 2016-222455 discloses an art in which combinations of items with close shipment conditions such as scheduled dates of shipment are divided into groups, and the items in the identical group are disposed in an identical area. In this art, since the items with close shipment conditions can be disposed close to each other, time for a worker to pick the items can be shortened, and the shipment work can be performed more efficiently.

### SUMMARY

In the art described in Japanese Patent Laid-Open No. 2016-222455, although the items with close shipment conditions are disposed close to each other, this cannot always improve the work efficiency or there is a concern that the work efficiency is lowered depending on the cases. For example, when a worker picks items by using a cart, there are cases where the work efficiency becomes better by disposing the items at a place away to some degree in order to avoid jamming of the work.

An object of this disclosure is to provide a disposition optimization system and a disposition optimizing method capable of improving the work efficiency.

A disposition optimization system according to one embodiment of this disclosure is a disposition optimization system configured to conduct analysis on disposition of a plurality of disposition targets and has a storage portion configured to store work achievement information indicating the disposition target related to the work, an actual disposition place where the disposition target is disposed, and actual work time taken for the work for each work and location information indicating a plurality of disposition places capable of disposing the disposition targets, a control portion configured to acquire a mutual action search policy including a plurality of mutual action emergence patterns indicating a relation between two of the disposition places influencing the work time taken for the work, and a generating portion configured to generate a disposition plan indicating a plan of the disposition place where the disposition target is disposed on the basis of the work achievement information, the location information, and the mutual action search policy.

Moreover, a disposition optimizing method according to the embodiment of this disclosure is a disposition optimizing method of conducting analysis on the disposition of the plurality of disposition targets, in which work achievement information indicating the disposition target related to the work, an actual disposition place where the disposition target is disposed, and actual work time taken for the work for each work and location information indicating a plurality of disposition places capable of disposing the disposition targets are stored, a mutual action search policy including a plurality of mutual action emergence patterns indicating a relation between two of the disposition places influencing the work time taken for the work is acquired, and a disposition plan indicating a plan of the disposition place where the disposition target is disposed is generated on the basis of the work achievement information, the location information, and the mutual action search policy.

According to this disclosure, the work efficiency can be improved.

### BRIEF DESCRIPTION OF THE DRAWINGS

FIG. 1 is a configuration diagram illustrating an example of a disposition optimization system of a first embodiment according to this disclosure;

FIG. 2 is a diagram illustrating an example of a work achievement table;

FIG. 3 is a diagram illustrating an example of location information;

FIG. 4 is a diagram illustrating an example of a mutual action search policy;

FIG. 5 is a diagram illustrating an example of items combination information;

FIG. 6 is a diagram illustrating an example of mutual action information;

FIG. 7 is a diagram illustrating an example of a disposition change plan;

FIG. 8 is a diagram illustrating an example of a display screen;

FIG. 9 is a flowchart for explaining an example of an operation of the disposition optimization system of the first embodiment according to this disclosure;

FIG. 10 is a flowchart for explaining an example of the operation of the disposition optimization system of a second embodiment according to this disclosure;

FIG. 11 is a configuration diagram illustrating an example of the disposition optimization system of a third embodiment according to this disclosure; and

FIG. 12 is a diagram illustrating an example of a mutual action emergence pattern template.

### DETAILED DESCRIPTION OF THE EMBODIMENTS

Hereinafter, embodiments of this disclosure will be described by referring to the drawings. Identical reference numerals are given to those having the identical functions in each drawing, and the description will be omitted in some cases.

### First Embodiment

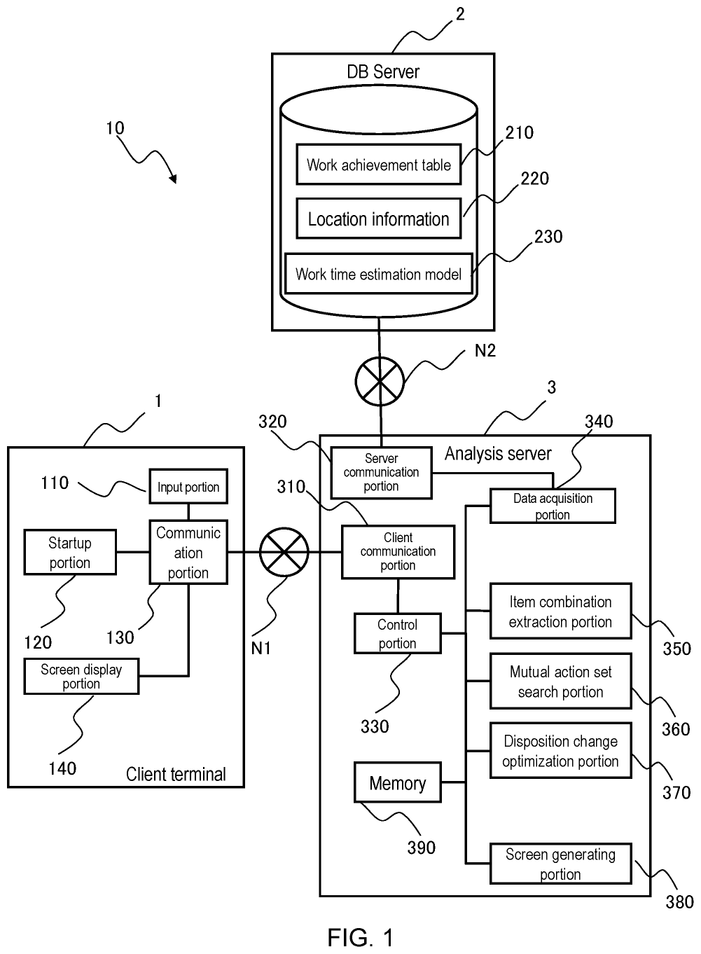

FIG. 1 is a configuration diagram illustrating an example of a disposition optimization system of a first embodiment according to this disclosure. A disposition optimization system 10 illustrated in FIG. 1 is assumed to be used for analysis of disposition of items in a warehouse in a warehousing work unless otherwise specifically noted. However, the disposition optimization system 10 can be also used for other applications as will be described later.

As illustrated in FIG. 1, the disposition optimization system 10 has a client terminal 1, a DB (Database) server 2, and an analysis server 3. The client terminal 1 and the analysis server 3 are coupled, capable of communication with each other through a network N1, and the DB server 2 and the analysis server 3 are coupled, capable of communication with each other through a network N2. Functions of the client terminal 1, the DB server 2, and the analysis server 3 may be realized by recording a program which realizes the functions in a computer-readable recording medium and by causing the computer to read and execute the program recorded in this recording medium. The program may be resident or may be started before the functions by the program are to be executed.

The client terminal 1 is a terminal apparatus operated by an analyst who is a user using the disposition optimization system 10. The client terminal 1 includes an input portion 110, a startup portion 120, a communication portion 130, and a screen display portion 140.

The input portion 110 receives various kinds of information from the analyst.

The startup portion 120 outputs a start signal requesting start of analysis on disposition of the items which are disposition targets and access information for making an access to the DB server 2 storing information for analysis which is information required for analysis.

The communication portion 130 is coupled to the analysis server 3, capable of communication. The communication portion 130 transmits the start signal and the access information output from the startup portion 120 to the analysis server 3. Moreover, the communication portion 130 receives data for display from the analysis server 3.

The screen display portion 140 displays a screen according to the data for display received by the communication portion 130.

The DB server 2 is a storage portion configured to store the information for analysis which is the information required for analysis on the disposition of the items. In this embodiment, the DB server 2 stores a work achievement table 210 which is work achievement information related to the work of the items, location information 220 indicating the disposition place capable of disposing the items as the information for analysis, and a work time estimation model 230 for estimating work time taken for the work.

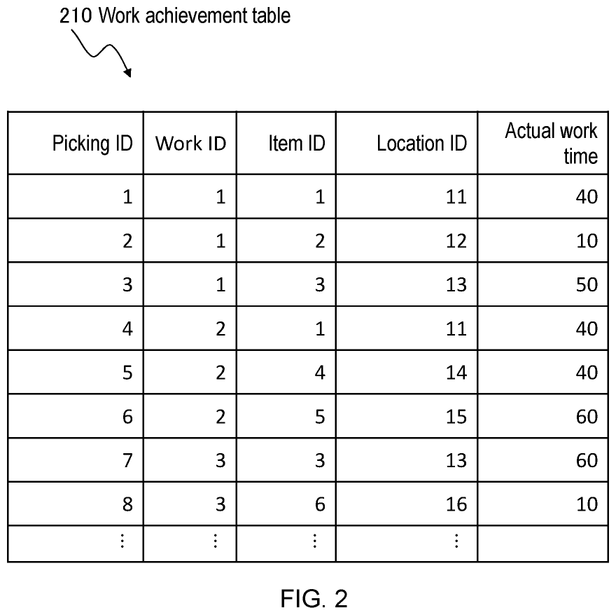

FIG. 2 is a diagram illustrating an example of the work achievement table 210. As illustrated in FIG. 2, the work achievement table 210 is a table related to a work (a picking work, here) actually performed for the items in the warehouse. More specifically, the work achievement table 210 shows a work (Work) ID specifying the Work subjected to the picking work, an item ID specifying an item related to the picking work (an item taken out by the picking work), a location ID specifying an actual disposition place which is a disposition place where the item is actually disposed, and actual work time which is work time actually taken for the picking work for each picking ID specifying the picking work. The Work is an operation unit for which the picking work is performed once or a plurality of times and indicates an operation from when a worker picks one or a plurality of item at a predetermined position till when the worker returns to the predetermined position, for example. The actual work time is time from a time point when the worker leaves the predetermined position or at a time point when the picking work immediately before is finished to a point of time when the picking work is finished or a time point when the worker returns to the predetermined position, for example. A unit of the work time is not particularly limited, but it is seconds in the illustrated example.

A format of the work achievement table 210 illustrated in FIG. 2 is only an example and is not limiting. For example, it may be so configured that the item ID and the location ID are managed by separate tables and a correspondence relation between the item ID and the location ID is indicated by other information such as inventory information of the items.

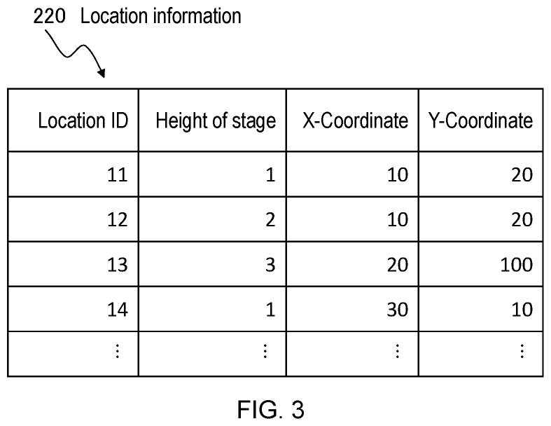

FIG. 3 is a diagram illustrating an example of the location information 220. The location information 220, as illustrated in FIG. 3, indicates a disposition place capable of disposing the items for each item ID. In the illustrated example, the disposition place is specified by a position on a two-dimensional area where the item is disposed (an area in which a rack on which the item is disposed in the warehouse is provided, for example) and a height in plural stages from the two-dimensional area. The position on the two-dimensional area is indicated by coordinates (X-coordinate and Y-coordinate), and the height is indicated by the number of stages (stage height) in the rack on which the items are disposed.

The work achievement table 210 and the location information 220 are acquired in advance before start of the analysis and stored in the DB server 2. A method of acquiring the work achievement table 210 and the location information 220 is not particularly limited. If a general warehouse management system is used in a warehousing operation, for example, since information corresponding to the work achievement table 210 and the location information 220 is managed by the warehouse management system in many cases, those kinds of information managed by the warehouse management system can be stored in the DB server 2 in advance as the work achievement table 210 and the location information 220 in such a situation. In this case, there is no need to newly acquire the work achievement table 210 and the location information 220 for this analysis.

The work time estimation model 230 is a model for outputting estimated work time which is an estimation value estimating the work time by using an item disposition plan as an input and applying the input disposition plan. More specifically, the estimated work time is the estimation value of the work time when the picking work for the identical items as those in the picking work indicated in the work achievement table 210 is performed with the identical Work. The work time estimation model 230 may output each work time taken for each picking work or may output a statistic value (a total sum or an average value, for example) of each work time. The work time estimation model 230 includes a regression model for outputting an estimated work time, calculates an explanatory variable from the input disposition plan, inputs the explanatory variable into the regression model and outputs the estimated work time, for example. The regression model can be prepared in advance on the basis of the explanatory variable prepared on the basis of the work achievement table 210 by using regression analysis.

The information for analysis may include other information such as an item information table indicating item information related to the item for each item ID. The item information is a weight, capacity, outer dimension of the item and the like, for example.

The analysis server 3 is an analyzing apparatus configured to conduct analysis on disposition of the items on the basis of the information for analysis stored in the DB server 2. The analysis server 3 includes a client communication portion 310, a server communication portion 320, a control portion 330, a data acquisition portion 340, an item combination extraction portion 350, a mutual action set search portion 360, a disposition change optimization portion 370, a screen generating portion 380, and a memory 390.

The client communication portion 310 is coupled to the client terminal 1, capable of communication. The client communication portion 310 receives a start signal and access information from the client terminal 1, for example.

The server communication portion 320 is coupled to the DB server 2, capable of communication. The server communication portion 320 receives the information for analysis from the DB server 2, for example.

The control portion 330 controls the entire analysis server 3. The control portion 330 controls start timing of each portion in the analysis server 3, for example. Moreover, when the client communication portion 310 receives the start signal, the control portion 330 determines start of the analysis and outputs the access information received by the client communication portion 310 to the data acquisition portion 340. Moreover, the control portion 330 acquires a mutual action search policy indicating a plurality of mutual action emergence patterns indicating a relation between two disposition places influencing the work time of the picking work and a search importance degree which is a degree of importance of each of the mutual action emergence patterns, and records it in the memory 390.

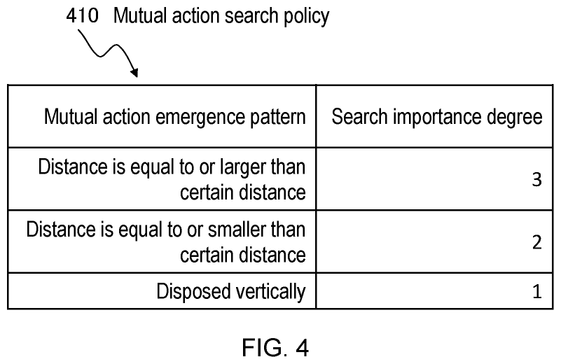

FIG. 4 is a diagram illustrating an example of the mutual action search policy. The mutual action search policy 410 illustrated in FIG. 4 indicates the search importance degree for each mutual action emergence pattern. There are three mutual action emergence patterns, that is, a “distance is equal to or larger than certain value” in which a distance between the two disposition places is equal to or larger than a certain value, a “distance is equal to or smaller than certain value” in which the distance between the two disposition places is equal to or smaller than a certain value, and “disposed vertically” in which the two disposition places are aligned in a height direction and the heights are different only by one stage. The distance between the two disposition places is a distance on the two-dimensional area expressed by the X-coordinate and the Y-coordinate.

In this embodiment, the mutual action search policy is acquired through the client terminal 1. More specifically, the control portion 330 transmits an input request requesting an input of the mutual action search policy as a request of initial configuration to the client terminal 1 through the client communication portion 310. After that, when the client communication portion 310 receives the mutual action search policy input into the client terminal 1, the control portion 330 acquires the mutual action search policy. In the client terminal 1, the communication portion 130 receives the input request, and the screen display portion 140 displays the input request. After that, when the input portion 110 receives the mutual action search policy from the analyst, the communication portion 130 transmits the mutual action search policy to the analysis server 3. The input request is the data for display, and in this embodiment, it is generated in the screen generating portion 380 as will be described later.

In this embodiment, the mutual action emergence patterns in the mutual action search policy are determined in advance, and the input requests include a list of the mutual action emergence patterns in the mutual action search policy and request an input of the respective search importance degrees of the mutual action emergence patterns in the list. In this case, the mutual action emergence patterns may be stored in the DB server 2 or may be hard-coded in a program. Both the mutual action emergence patterns of the mutual action search policy and the search importance degrees may be determined in advance. Moreover, timing when the control portion 330 transmits the input request is timing when the data acquisition portion 340 which will be described later records the information for analysis in the memory 390, for example.

The data acquisition portion 340 acquires the information for analysis from the DB server 2 on the basis of the access information from the control portion 330. More specifically, the data acquisition portion 340 generates an acquisition request of the information for analysis on the basis of the access information from the control portion 330 and transmits it to the DB server 2 through the server communication portion 320 and then, acquires the information for analysis received in the server communication portion 320. The data acquisition portion 340 records the acquired information for analysis in the memory 390.

The item combination extraction portion 350, the mutual action set search portion 360, and the disposition change optimization portion 370 configure a generating portion for generating a disposition change plan which is a disposition plan for the items on the basis of the information for analysis recorded in the memory 390 and the mutual action search policy.

The item combination extraction portion 350 extracts item combination information indicating a predetermined item combination (a combination of two items) which is a target combination from the work achievement table 210 recorded in the memory 390 and records it in the memory 390.

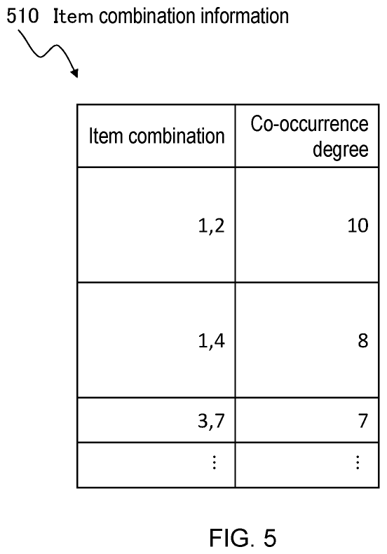

FIG. 5 is a diagram illustrating an example of the item combination information. Item combination information 510 illustrated in FIG. 5 indicates a cooccurrence degree which is an importance degree of the item combination for each item combination indicating the item IDs of the two items.

The mutual action set search portion 360 generates mutual action information indicating the relation between the item combination from which improvement of the work time is estimated and the mutual action emergence pattern by using the information for analysis recorded in the memory 390 (the work achievement table 210, the location information 220, and the work time estimation model 230) and the item combination information extracted in the item combination extraction portion 350 and records it in the memory 390.

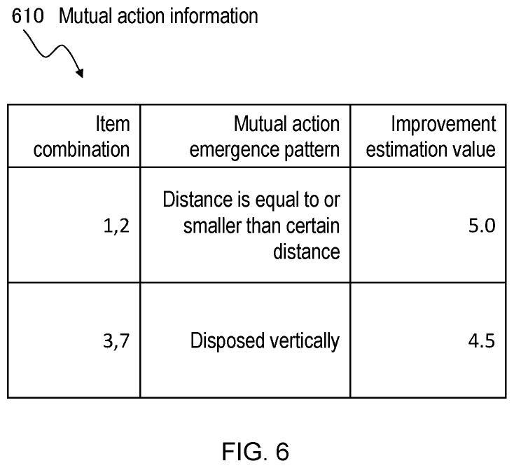

FIG. 6 is a diagram illustrating an example of the mutual action information. The mutual action information 610 illustrated in FIG. 6 indicates the mutual action emergence pattern of the disposition places where the items identified by two item IDs in the item combination are disposed and the improvement estimation value which is an estimation value of the improvement degree by which the work time is improved for each combination of the item for each an item combination.

The disposition change optimization portion 370 generates a disposition change plan of items by using the work achievement table 210 of the information for analysis recorded in the memory 390, the work time estimation model 230, and the mutual action information generated in the mutual action set search portion 360.

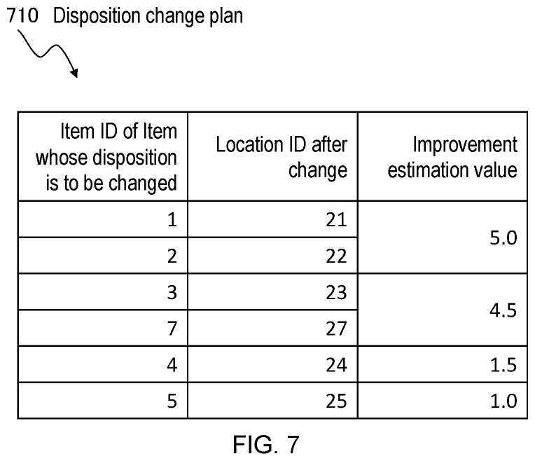

FIG. 7 is a diagram illustrating an example of the disposition change plan. The disposition change plan 710 illustrated in FIG. 7 indicates the location ID (the location ID after the change) specifying the disposition place after the change of the items and the improvement estimation value which is an estimation value of the improvement degree by which the work time is improved by the change of the disposition for each item ID of the items whose disposition is to be changed.

The screen generating portion 380 generates data for display indicating the display screen to be displayed on the client terminal 1 and transmits the data for display to the client terminal 1 through the control portion 330 and the client communication portion 310.

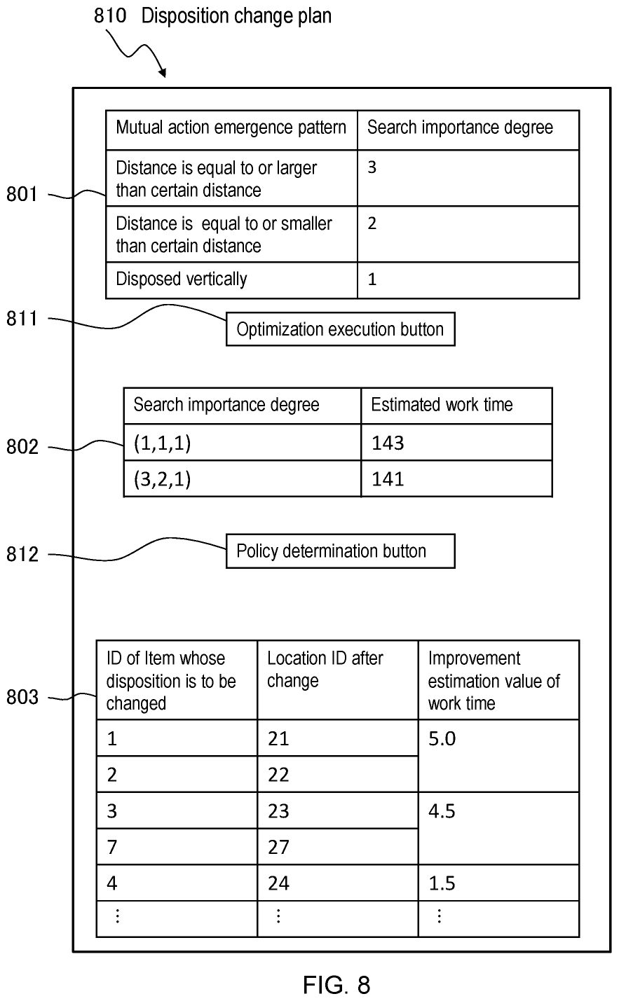

FIG. 8 is a diagram illustrating an example of the display screen. The display screen 810 illustrated in FIG. 8 includes a first table 801 indicating the mutual action search policy, a second table 802 indicating a relation between the search importance degree and the estimated work time, and a third table 803 indicating the disposition change plan. Moreover, the display screen 810 includes an optimization execution button 811 which is a button for transmitting the mutual action search policy and a policy determination button 812 which is a button for outputting the disposition change plan.

In this embodiment, first, as an input request, the screen generating portion 380 generates and transmits the data for display indicating the display screen 810 including the first table 801 with the search importance degree blank and the optimization execution button 811 to the client terminal 1. After that, when the search importance degree is input in the client terminal 1, and the optimization execution button 811 is pressed, the input search importance degree is transmitted to the analysis server 3. After that, in the middle of the analysis on the disposition of the items, the data for display indicating the display screen 810 further including the first line of the second table 802 and the policy determination button 812 is generated and transmitted to the client terminal 1.

When the analyst checks the second table 802 and the search importance degree is re-adjusted, the search importance degree is input again, and moreover, the optimization execution button 811 is pressed again. Each time the optimization execution button 811 is pressed, the screen generating portion 380 adds one line to the second table 802.

Moreover, when the line is selected from the second table 802, and when the policy determination button 812 is further pressed, the disposition change plan according to the selected search importance degree is generated in the disposition change optimization portion 370, and the screen generating portion 380 generates and transmits the data for display indicating the display screen 810 further including the third table 803 indicating the disposition change plan to the client terminal 1.

The configuration described above is only an example and this configuration is not limiting. For example, the functions of the client terminal 1, the DB server 2, and the analysis server 3 may be realized by one, two or four units or more of the devices.

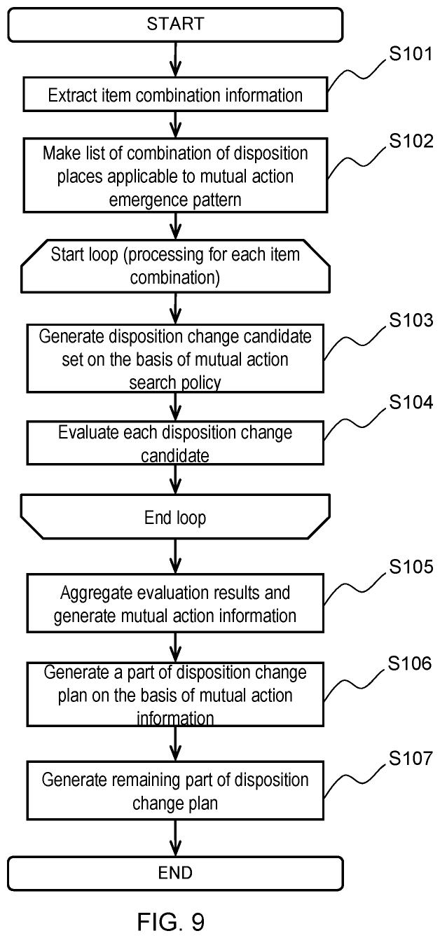

FIG. 9 is a flowchart for explaining an example of an operation of the disposition optimization system 10. More specifically, FIG. 9 is a flowchart for explaining an example of an operation of the generating portion (the item combination extraction portion 350, the mutual action set search portion 360, and the disposition change optimization portion 370). In FIG. 9, processing at Step S101 is executed in the item combination extraction portion 350, processing at Steps S102 to S105 is executed in the mutual action set search portion 360, and processing at Steps S106 and S107 is executed in the disposition change optimization portion 370.

At Step S101, the item combination extraction portion 350 extracts the item combination information from the work achievement table 210 recorded in the memory 390. For example, the item combination extraction portion 350 counts the number of times when the picking work is performed for the identical Work (Work identified by the identical work ID) with respect to the two items identified by those item IDs for the combinations of all the item IDs as the cooccurrence degree on the basis of the work achievement table 210. Then, the item combination extraction portion 350 generates a list in which the combinations of the item IDs are listed in the order from the higher cooccurrence degree and extracts the list with the combinations of each of the item IDs associated with the cooccurrence degrees as the item combination information.

At this time, the item combination extraction portion 350 may select the item combination (combination of the item IDs) to be included in the item combination information in accordance with the cooccurrence degree. For example, the item combination extraction portion 350 may select the item combination with the cooccurrence degree equal to or larger than a predetermined value or may select the item combination for a predetermined number of pieces from the higher cooccurrence degree.

At Step S102, the mutual action set search portion 360 extracts the location combination information indicating a combination of the disposition places applicable to the mutual action emergence pattern from the location information 220 recorded in the memory 390 for each of the plurality of mutual action emergence patterns included in the mutual action search policy recorded in the memory 390.

More specifically, the mutual action set search portion 360 determines whether or not all the combinations (pairs) configured by the location IDs in the location information 220 satisfy each of the mutual action emergence pattern or not and extracts a list of the combinations of the location IDs satisfying the mutual action emergence pattern as the location combination information.

For example, if the mutual action emergence pattern is “the distance is equal to or smaller than certain value”, the mutual action set search portion 360 calculates a distance between the two disposition places from the coordinates corresponding to the two location IDs, and if the distance is equal to or smaller than a certain value, it is determined that those location IDs are applicable to the mutual action emergence pattern. The certain value may be determined in advance or may be configured by the analyst or the like at initial configuration or the like. A method of determining the certain value in advance includes hard-coding in the program, for example. For example, if the certain value is 50 and the location information 220 is information illustrated in FIG. 3, the location ID pairs with the “distance is equal to or smaller than certain value” are {{11, 12}, {11, 14}, {12, 14}, . . . }. Moreover, if the mutual action emergence pattern is “distance is equal to or larger than certain”, the “or smaller” only needs to read “or larger” in the description above. If the mutual action emergence pattern is “disposed vertically”, the mutual action set search portion 360 determines that two location IDs are applicable to the mutual action emergence pattern if the coordinates corresponding to those location IDs match each other and the height is different only by one stage.

When the processing at Step S102 is finished, the mutual action set search portion 360 executes processing at Steps S103 and S104 for each item combination in the item combination information.

At Step S103, the mutual action set search portion 360 generates a disposition change candidate set which is a set of the candidates for the disposition places where each item of the item combination is disposed on the basis of the mutual action search policy recorded in the memory 390 for each of the plurality of mutual action emergence patterns.

More specifically, the mutual action set search portion 360 first extracts K pieces of location combinations including the location ID specifying the disposition place applicable to each of the mutual action emergence patterns in the mutual action search policy as a representative disposition place from the location combination information generated at Step S102. K is the number according to the search importance degree of the mutual action emergence pattern and the search importance degree itself here. An extraction method of extracting the location ID combination is not particularly limited but random extraction, here.

Subsequently, the mutual action set search portion 360 generates information in which the item ID in the item combination is allocated to each of the K pieces of location combinations as the disposition change candidate set. For example, if the list of the extracted location combinations is {{11, 12}, {13,14}, . . . } and the item ID in the item combination is {p1, p2}, the mutual action set search portion 360 generates {{(p1, 11), (p2, 12)}, {(p1, 13), (p2, 14)}, . . . } as the disposition change candidate set. Here, each element {(pa, 1b), (pc, 1d)} of the disposition change candidate set indicates that the item pa is disposed at a disposition place 1b, and the item pc is disposed at a disposition place 1d. For example, the first element of the disposition change candidate set {(p1, 11), (p2, 12)} indicates that the item p1 is disposed at the disposition place 11, and the item p2 is disposed at the disposition place 12. Each element of the disposition change candidate set is a disposition change candidate which is a candidate of the disposition place.

At Step S103, the combination of the location IDs is extracted from the location combination information, not depending on the item combination information, but the combination of the location IDs according to the item combination information may be extracted. For example, the mutual action set search portion 360 extracts K pieces of the combinations of location IDs from the combinations of location IDs satisfying restriction according to the item combination information in all the combinations of location IDs in the location combination information. The restriction according to the item combination information is determined in accordance with the item information of each item in the item combination information (weight, capacity, outer dimension and the like), for example.

At Step S104, the mutual action set search portion 360 evaluates each of the disposition change candidates of the disposition change candidate set by using the work time estimation model recorded in the memory 390 for each of the plurality of mutual action emergence patterns. More specifically, the mutual action set search portion 360 calculates the improvement estimation value which is an estimation value of the improvement degree of the work time by disposing the items at the disposition change candidate for each of the disposition change candidates. For example, for the disposition change candidate with {(p1, 11), (p2, 12)}, the mutual action set search portion 360 calculates the estimated work time when the item p1 is disposed at the disposition place 11 and the item p2 is disposed at the disposition place 12 by using the work time estimation model. Then, the mutual action set search portion 360 compares the estimated work time with the actual work time in the work achievement table 210 and calculates the improvement degree of the estimated work time from the actual work time as the improvement estimation value of the work time by disposing the items p1 and p2 at the disposition change candidates. The mutual action set search portion 360 generates the list indicating the improvement estimation value of each of the disposition change candidates for each mutual action emergence pattern as an evaluation result.

The evaluation result is specifically a disposition change candidate set with estimation value {(p1, 11), (p2, 12), N1, T1}, {(p1, 13), (p2, 14), N2, T2}, . . . } obtained by adding the name Ni of the corresponding mutual action emergence pattern and the improvement estimation value Ti of the work time to each of the disposition change candidates in the disposition change candidate set generated at Step S103. Reference character Ni is any one of the names of the mutual action emergence patterns included in the mutual action search policy (“distance is equal to or larger than certain value”, “distance is equal to or smaller than certain value”, and “disposed vertically”).

At Step S105, the mutual action set search portion 360 generates mutual action information by aggregating the evaluation results generated at Step S104. More specifically, the mutual action set search portion 360 sorts each element of the disposition change candidate set with the estimation value in the order from the one with a larger improvement estimation value T of the work time. Then, the mutual action set search portion 360 generates the elements for the predetermined value N portion in the order from the one with the larger estimation value T included in the disposition change candidate set with the estimation value as the mutual action information. The predetermined value N may be determined in advance by hard-coding in the program or may be configured by the analyst or the like at initial configuration or the like. The mutual action information indicates the mutual action emergence patterns of the disposition places where the items identified by the two item IDs in the item combination are disposed and the improvement estimation value for each item combination as illustrated in FIG. 6. The mutual action information illustrated in FIG. 6 is an example in the case of N=2.

At Step S106, the disposition change optimization portion 370 generates a part of the disposition change plan on the basis of the mutual action information generated at Step S105. More specifically, the disposition change optimization portion 370 searches for the disposition place where the improvement estimation value T is the maximum in the disposition places applicable to the mutual action emergence pattern corresponding to the item combination in the order from the item combination with the higher improvement estimation value T in the mutual action information and generates the disposition place where the estimation value T is the maximum as a part of the disposition change plan.

For example, if the element with the improvement estimation value in the mutual action information the maximum is {item combination: {1, 2}, mutual action emergence pattern: distance is equal to or smaller than a certain value, improvement estimation value: T}, the disposition change optimization portion 370 inputs the disposition plan in which the items {1} and {2} are disposed at all the disposition places with the distance equal to or smaller than the certain value into the work time estimation model 230 and calculates the improvement estimation value of the work time. The disposition change optimization portion 370 generates the plan in which the items {1} and {2} are disposed at each of the combinations of the disposition places where the improvement estimation value becomes the maximum as a part of the disposition change plan. For example, assuming that the improvement estimation value becomes 5.0 which is the maximum when the items {1} is disposed at the disposition place {21} and the item {2} is disposed at the disposition place {22}, a part of the disposition change plan as the first two lines in the disposition change plan in FIG. 7 is generated. Since this processing is repeated for the predetermined value N times, in the case of the mutual action information with N=2 as in FIG. 6, for example, the first four lines in the disposition change plan in FIG. 7 are generated as the part of the disposition change plan.

At Step S107, the disposition change optimization portion 370 generates the remaining part of the disposition change plan and generates the disposition change plan by merging the remaining part with the part of the disposition change plan generated at S106. The remaining part of the disposition change plan is a part for which the mutual action (influence on the work time by the disposition relation) is not considered. The disposition change optimization portion 370 generates the disposition change plan so that the number of items whose disposition places are to be changed from the actual disposition places becomes a value equal to or smaller than a specified value M. The specified value M may be determined in advance by hard-coding in a program or may be configured by the analyst or the like at the initial configuration or the like.

More specifically, the disposition change optimization portion 370 executes the processing of calculating the improvement estimation value of the work time by inputting the disposition plan in which only one items whose disposition place is changed from the actual disposition place into the work time estimation model 230 for all the items and for all the disposition places and acquires a combination of the disposition places where the sum of the improvement estimation values of all the items becomes the maximum. Then, the disposition change optimization portion 370 generates the remaining part of the disposition change plan from the combinations of the disposition places so that the number of items whose disposition places are changed from the actual disposition places becomes a value equal to or smaller than a specified value K in the disposition change plan. The combination of the disposition places where the sum of the improvement estimation values becomes the maximum can be acquired by using an existing algorithm or the like related to the maximum matching problem.

The disposition change plan in FIG. 7 has K=6, in which the first four lines are the part of the disposition change plan calculated at Step S106, and the last two lines are the remaining part of the disposition change plan calculated at Step S107.

The configuration and operation of this embodiment described above is only an example and is not limiting.

For example, in the middle of the operation illustrated in FIG. 9 (after the processing at Step S105 is finished, for example), the screen generating portion 380 may generate and transmit the data for display including the second table 802 and the policy determination button 812 illustrated in FIG. 8 to the client terminal 1. In this case, when the policy determination button 812 is pressed, the processing is continued, while if the optimization execution button 811 is pressed, the routine returns to the processing at Step S103.

Moreover, the mutual action emergence pattern is not limited to the aforementioned example but can be changed as appropriate. For example, the number of the mutual action emergence patterns is not limited to three as long as it is plural. Moreover, the mutual action emergence patterns may be the following four basic mutual action emergence patterns and any two or more of logical products of an arbitrary plurality of patterns in the four basic mutual action emergence patterns:
First basic mutual action emergence pattern: “the distance or a difference in a location management code is equal to or smaller than a certain value”
Second basic mutual action emergence pattern: “the distance or a difference in the location management code is equal to or larger than a certain value”
Third basic mutual action emergence pattern: “the distance or each location management code is a specific value”
Fourth basic mutual action emergence pattern: “location management codes match each other”

The location management code is identification information allocated to a unit including one or a plurality of disposition places and information generalizing a row, series, and stage of the rack on which the item is disposed. Various mutual action emergence patterns can be expressed by using the location management code. For example, the mutual action emergence pattern such as the “difference in the stage height is two stages or less” can be expressed by using the first basic mutual action emergence pattern. Moreover, the mutual action emergence pattern such as the “stage heights are both the first stage”, for example, can be expressed by using the third basic mutual action emergence pattern. Moreover, the mutual action emergence pattern such as the “identical row” can be expressed by using the fourth basic mutual action emergence pattern.

When the location management code is used in the mutual action emergence pattern, the row indicating the location management code is included in the location information 220.

When the logical product of the basic mutual action emergence patterns is used, more complicated mutual action emergence pattern such as the “identical row, distance equal to or larger than the certain value, and the difference in the stage height is two stages or less” can be expressed.

Moreover, the disposition optimization system 10 can be applied to the disposition problem other than the disposition of items in the warehouse by configuring the mutual action search policy as appropriate. For example, the disposition optimization system 10 can be also applied to the disposition problem of staff in a production line for generating a target in a plant.

In the case of the disposition problem of staff, the disposition targets are the staff, and the work achievement table 210 is a table related to a work of the production line actually performed by the staff and indicates a corresponding relation between the disposition of the staff and the work time. The location information 220 is information indicating the disposition place where the staff can be disposed. The work time estimation model 230 is a model for outputting the estimated work time which is an estimation value of the work time with the disposition plan of the staff as an input when the input disposition plan is applied and can be prepared in advance on the basis of the explanatory variable generated on the basis of the work achievement table 210 by using the regression analysis similarly to the example of the disposition problem of the items.

In the production line, when places with high work difficulty degree are adjacent to each other, there is a concern of large deterioration in efficiency unless a skilled worker who can be efficiently linked to those places is disposed and thus, examples of the mutual action emergence pattern can include the “disposition places are adjacent, the sum of the work difficulty degrees is equal to or larger than a certain value”, and the “disposition places are adjacent and the sum of the work difficulty degrees is equal to or smaller than a certain value” and the like. A work difficulty degree is determined in accordance with the number of targets processed in certain time or the like, for example.

### Second Embodiment

In the first embodiment, although the search importance degree of the mutual action search policy is input by the analyst, in this embodiment, the analysis server 3 automatically generates the search importance degree.

In this embodiment, the control portion 330 transmits a time input request requesting an input of designated execution time which is time taken for configuration of the mutual action search policy (search importance degree) to the client terminal 1 through the client communication portion 310 instead of the input request requesting an input of the mutual action search policy as the request for initial configuration. After that, when the client communication portion 310 receives the designated execution time input into the client terminal 1, the control portion 330 acquires the designated execution time and records it in the memory 390. In the client terminal 1, the communication portion 130 receives the time input request, and the screen display portion 140 displays the time input request. After that, when the input portion 110 receives the designated execution time from the analyst, the communication portion 130 transmits the designated execution time to the analysis server 3.

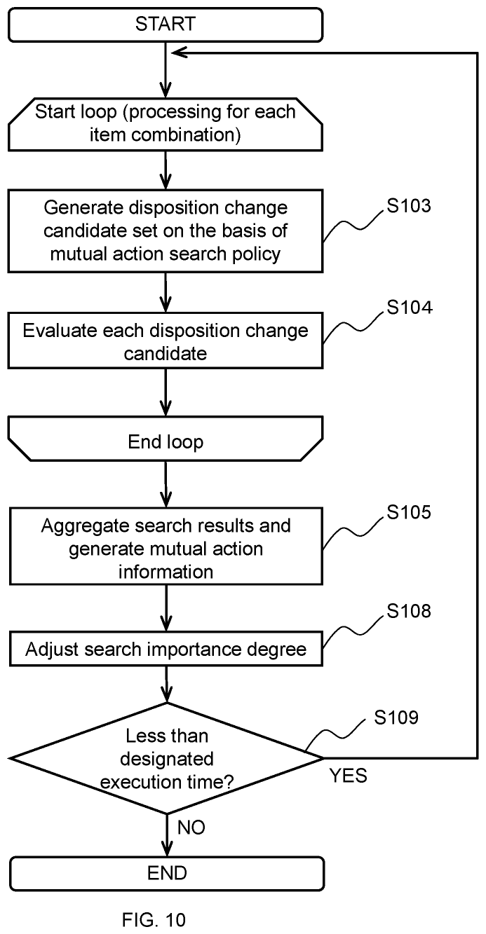

Moreover, the processing by the mutual action set search portion 360 is different from that in the first embodiment. FIG. 10 is a flowchart for explaining an example of the operation of the mutual action set search portion 360 in this embodiment.

First, the mutual action set search portion 360 sets the search importance degree of each of the mutual action emergence patterns in the mutual action search policy to an initial value and executes processing similar to that from Step S103 to Step S105 illustrated in FIG. 9. All the initial values of the search importance degrees are 1, for example.

After the processing at Step S105 is finished, at Step S108, the mutual action set search portion 360 adjusts the search importance degree in the mutual action search policy.

More specifically, the mutual action set search portion 360 first acquires the mutual action emergence pattern search effect for each of the mutual action emergence patterns. The mutual action emergence pattern search effect is a degree of improvement of the work time at the current search importance degree, and in this embodiment, it is a maximum value of the improvement estimation value of the mutual action information generated at Step S105. The mutual action set search portion 360 increases the search importance degree of the mutual action emergence pattern with the highest mutual action emergence pattern search effect. An increase amount of the search importance degree is 1, for example.

At Step S109, the mutual action set search portion 360 determines whether the execution time of the processing by itself (the mutual action set search portion 360) is less than the designated execution time or not. If the execution time is less than the designated execution time, the mutual action set search portion 360 returns to the processing at Step S103. At this time, the search importance degree adjusted at Step S108 is used for the search importance degree of the mutual action emergence pattern. On the other hand, if the execution time is equal to or larger than the designated execution time, the mutual action set search portion 360 ends the processing. After that, the processing of the disposition change optimization portion 370 (Step S106 and S107) illustrated in FIG. 9 is executed.

In the aforementioned operation, the loop including Step S103 and Step S104 is likely to be executed a plurality of times. Thus, it may be so configured that each time the loop is finished, the mutual action set search portion 360 records a processing result by the loop in the memory 390, and when the loop is executed again, only the processing related to the mutual action emergence pattern with the search importance degree increased in the adjustment immediately before is re-executed by using the processing result recorded in the memory 390. Moreover, the designated execution time may be determined in advance.

### Third Embodiment

In the first embodiment, although the mutual action emergence pattern of the mutual action search policy is determined in advance, in this embodiment, the analyst selects the mutual action emergence pattern.

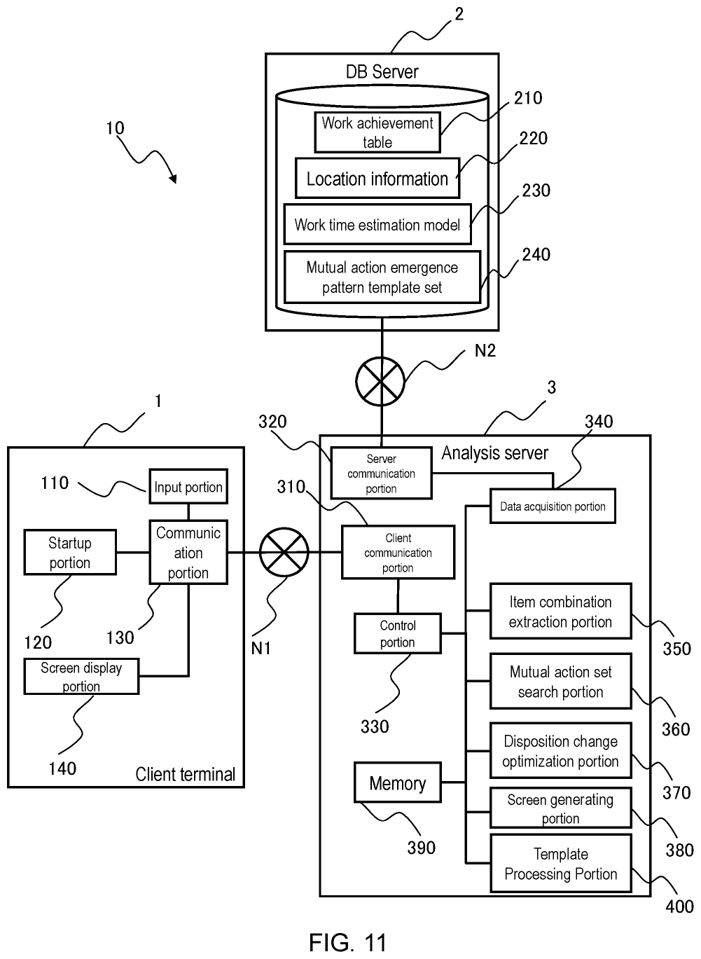

FIG. 11 is a configuration diagram illustrating an example of the disposition optimization system of this embodiment. The disposition optimization system 10 illustrated in FIG. 11 is different from the disposition optimization system 10 in the first embodiment illustrated in FIG. 1 in points that the DB server 2 further stores a mutual action emergence pattern template set 240 as the information for analysis and the analysis server 3 further has a template processing portion 400.

The mutual action emergence pattern template set (hereinafter abbreviated as a template set) 240 is a set of templates indicating the mutual action emergence patterns. Each template in the template set 240 may be registered in advance or may be capable of new registration as necessary.

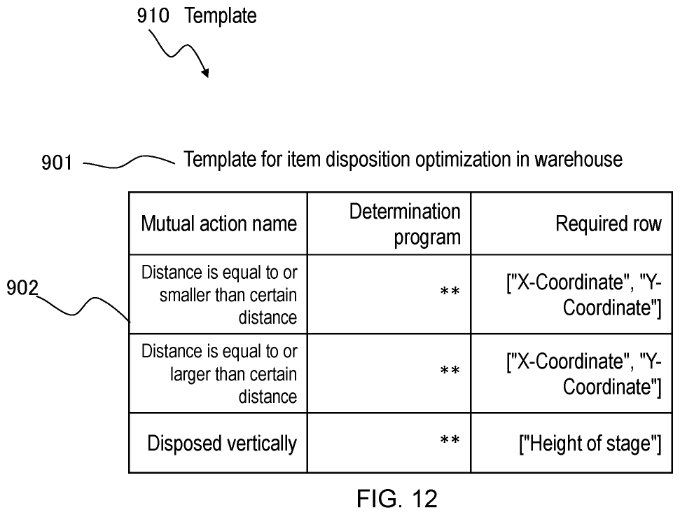

FIG. 12 is a diagram illustrating an example of the template included in the template set 240. The template 910 illustrated in FIG. 12 is a template for items disposition optimization in a warehouse corresponding to the three mutual action emergence patterns (“distance is equal to or larger than certain value”, “distance is equal to or smaller than certain value”, and “disposed vertically”) described in the first embodiment.

As illustrated in FIG. 12, the template 910 includes a template identifier 901 which identifies the template 910 and a mutual action item list 902. The mutual action item list 902 indicates a determining program which is a program for extracting the combination of the disposition places applicable to the mutual action emergence pattern from the location information 220 for each of the mutual action names which are names of the mutual action emergence patterns and a required row which is information required for conducting analysis by using the mutual action emergence pattern. The required row indicates a name of the row included in the location information 220 required for conducting analysis by using the mutual action emergence pattern.

The template processing portion 400 acquires the template set 240 from the DB server 2 through the data acquisition portion 340 and the server communication portion 320 before initial configuration, generates a template selection request which is a selection request requesting selection of any one of the templates in the template set 240 and transmits it to the client terminal 1 through the client communication portion 310. The template selection request includes the template identifier 901 of each of the templates in the template set 240.

After that, when the client communication portion 310 receives the template identifier 901 of the template selected in the client terminal 1, the template processing portion 400 acquires the mutual action search policy on the basis of the template identified by the template identifier 901. More specifically, the template processing portion 400 generates a list of the mutual action emergence patterns included in the template. Then, the control portion 330 transmits the input request including the list of the mutual action emergence patterns generated by the template processing portion 400 to the client terminal 1 and acquires the mutual action search policy similarly to the first embodiment.

In the client terminal 1, when the communication portion 130 receives the template selection request, the screen display portion 140 displays the template selection request. After that, when the template is selected by an analyst in the input portion 110, the communication portion 130 transmits the template identifier 901 of the selected template to the analysis server 3. The template selection request is the data for display and may be generated by the screen generating portion 380.

Moreover, in this embodiment, when the location combination information applicable to the mutual action emergence pattern is to be extracted at Step S102 in FIG. 9, the determining program in the template identified by the template identifier 901 selected above is used.

As described above, this disclosure includes the following matters.

The disposition optimization system (10) according to a mode of this disclosure conducts analysis on the disposition of a plurality of targets (items) to be disposed. The storage portion (2) stores the work achievement information (210) indicating the disposition target related to the work, the actual disposition place where the disposition target is disposed, and the actual work time taken for the work for each work and stores the location information (220) indicating the plurality of disposition places where the disposition targets can be disposed. The control portion (330) acquires the mutual action search policy (410) including the plurality of mutual action emergence patterns indicating the relation between the two disposition places influencing the work time taken for the work. The generating portion (350, 360, 370) generates the disposition plan (disposition change plan) indicating the plan of a disposition place where the disposition target is disposed on the basis of the work achievement information, the location information, and the mutual action search policy.

In this case, the disposition plan indicating the plan of a disposition place where the disposition target is to be disposed on the basis of the mutual action search policy including the plurality of mutual action emergence patterns indicating the relation between the two disposition places influencing the work time taken for the work is generated. Therefore, the disposition plan can be generated by considering the plurality of relations related to the disposition places and thus, the work efficiency can be improved.

Moreover, the generating portion extracts the location combination including, as representative disposition places, two of the disposition places applicable to each of mutual action emergence patterns from the location information. The generating portion acquires estimated work time estimating the work time when the two disposition targets included in the target combination are disposed at the representative disposition places corresponding to each of the mutual action emergence patterns for each target combination of predetermined two disposition targets included in the plurality of disposition targets and generates the disposition plan on the basis of each estimated work time.

In this case, the disposition plan is generated for each of the representative disposition places applicable to each of the mutual action emergence patterns on the basis of the estimated work time when the predetermined two disposition targets are disposed. Therefore, since the disposition plan can be generated by considering the estimated work time, the disposition plan appropriate for improvement of the work efficiency can be proposed.

Moreover, the generating portion selects a predetermined number of the target combination in the order from the higher degree of improvement of the estimated work time from the actual work time and generates the disposition plan in which the disposition target included in the target combination is disposed at the disposition place where the improvement degree becomes the highest when it is disposed at each of the combination of the disposition places applicable to the mutual emergence pattern corresponding to the representative disposition place where the target combination is disposed for each of the selected target combinations. In this case, since the disposition plan in which the disposition target with the highest improvement degree of the work time is disposed at the disposition place with the highest improvement degree is generated, the disposition plan suitable for improvement of the work efficiency can be proposed.

Moreover, the work achievement information further indicates the Work which is an operation unit for which the work is performed for each work. The generating portion selects the target combination in accordance with the number of times (cooccurrence degree) related to the work in the identical Work from the combinations of the disposition targets configured by a plurality of the disposition targets. In this case, since the disposition plan related to the disposition target for which the work is often performed in the identical Work can be proposed, the improvement degree of the work time can be improved, and the work efficiency can be improved.

Moreover, the mutual action search policy further includes the search importance degree which is an importance degree of the mutual action emergence pattern for each mutual action emergence pattern. The generating portion extracts the location combination in the number according to the search importance degree of the mutual action emergence pattern for each mutual action emergence pattern. In this case, since location combinations in the number according to the importance degree of the mutual action emergence pattern are extracted, an appropriate disposition plan can be proposed in accordance with the importance degree of the mutual action emergence pattern, and the work efficiency can be improved.

Moreover, the control portion outputs the input request requesting an input of the search importance degree of each of the plurality of mutual action emergence patterns. When the search importance degree is input, the control portion acquires the mutual action search policy including the search importance degree and the plurality of mutual action emergence patterns. In this case, since the mutual action search policy including the input search importance degree is acquired, an appropriate search importance degree according to an experience of the analyst or the like can be used, and the work efficiency can be improved.

The generating portion acquires the improvement degree of the estimated work time from the actual work time for each of the mutual action emergence patterns and determines the search importance degree by repeating the processing of increasing the search importance degree of the mutual action emergence pattern with the highest improvement degree for the designated execution time. In this case, since the search importance degree of the mutual action emergence pattern with the high improvement degree of the estimated time becomes larger, the appropriate search importance degree can be used, and the work efficiency can be improved. Moreover, since the search importance degree can be automatically determined, a labor of a worker can be alleviated.

Moreover, the storage portion stores the set of the template indicating the plurality of mutual action emergence patterns (mutual action emergence pattern template set). The control portion outputs the selection request requesting selection of any one of the templates included in the set and when the template is selected, acquires the mutual action search policy on the basis of the selected template. In this case, since the appropriate mutual action emergence pattern according to the disposition target or situation can be used, the work efficiency can be improved.

Moreover, the disposition place is specified by the position on the two-dimensional area and the height in plural stages from the two-dimensional area. The plurality of mutual action emergence patterns indicates that the distance between the two disposition places on the two-dimensional area is equal to or smaller than the certain value, the distance is equal to or larger than the certain value, and the two disposition places are aligned in the height direction and the heights are different only by one stage. In this case, the disposition plan suitable for the disposition of items in the warehouse can be provided. Since it is expected that items disposed at disposition places with the heights different only by one stage can be picked by the worker substantially at the same time, the influence degree on the work time is considered to be high.

Moreover, the plurality of mutual action emergence patterns indicates that the distance between the two disposition places or the difference in the code (location management code) which is a numeral value allocated to each of the two disposition places is equal to or smaller than the certain value, the distance or the difference in the code is equal to or larger than the certain value, the distance or code is a specific value, each of the codes match each other, and any two or more of the logical products of the plurality of patterns in these patterns. In this case, since the complicated relation in the disposition places can be expressed by the mutual action emergence pattern, the appropriate mutual action emergence pattern according to the disposition target or situation can be used, and the work efficiency can be improved.

The aforementioned embodiments of the present invention are exemplification for explaining the present invention and are not intended to limit the range of the present invention to those embodiments. Those skilled in the art can implement the present invention in the other various modes without departing from the range of the present invention.

What is claimed is:

1. A disposition optimization system configured to conduct analysis on disposition of a plurality of disposition targets, comprising:
a storage portion configured to store work achievement information indicating, for each work, the disposition target related to the work, an actual disposition place where the disposition target is disposed, and actual work time taken for the work and to store location information indicating a plurality of disposition places capable of disposing the disposition targets;
a control portion configured to acquire a mutual action search policy including a plurality of mutual action emergence patterns indicating a relation between two of the disposition places influencing the work time taken for the work; and
a generating portion configured to generate a disposition plan indicating a plan of the disposition place where the disposition target is disposed on the basis of the work achievement information, the location information, and the mutual action search policy.

2. The disposition optimization system according to claim 1, wherein
the generating portion extracts a location combination including, as representative disposition places, two of the disposition places applicable to each of mutual action emergence patterns from the location information, acquires, for each target combination which is a combination of predetermined two disposition targets included in the plurality of disposition targets, estimated work time estimating the work time when two disposition targets included in the target combination are disposed at representative disposition places corresponding to each of the mutual action emergence patterns, and generates the disposition plan on the basis of each of the estimated work time.

3. The disposition optimization system according to claim 2, wherein
the generating portion selects a predetermined number of the target combinations in the order from a higher degree of improvement of the estimated work time from the actual work time and generates the disposition plan in which the disposition target included in the target combination is disposed at the disposition place where the improvement degree becomes the highest when the disposition target is disposed at each of the combination of the disposition places applicable to the mutual emergence pattern corresponding to the representative disposition place where the target combination is disposed for each of the selected target combinations.

4. The disposition optimization system according to claim 2, wherein
the work achievement information further indicates a Work which is an operation unit for which the work is performed for each of the works; and
the generating portion selects the target combination from the combinations of the disposition targets configured by the plurality of disposition targets on the basis of a number of times related to the work in the identical Work.

5. The disposition optimization system according to claim 2, wherein
the mutual action search policy further includes a search importance degree which is an importance degree of the mutual action emergence pattern for each of the mutual action emergence patterns; and
the generating portion extracts the location combinations in the number according to the search importance degree of the mutual action emergence pattern for each of the mutual action emergence patterns.

6. The disposition optimization system according to claim 5, wherein
the control portion outputs an input request requesting an input of the search importance degree of each of the plurality of mutual action emergence patterns and when the search importance degree is input, obtains the mutual action search policy including the search importance degree and the plurality of mutual action emergence patterns.

7. The disposition optimization system according to claim 5, wherein
the generating portion acquires the improvement degree of the estimated work time from the actual work time for each of the mutual action emergence patterns and determines the search importance degree by repeating processing of increasing the search importance degree of the mutual action emergence pattern with the highest improvement degree for designated execution time.

8. The disposition optimization system according to claim 1, wherein
the storage portion stores a set of templates indicating the plurality of mutual action emergence patterns; and
the control portion outputs a selection request requesting selection of any one of the templates included in the set and when the template is selected, acquires the mutual action search policy on the basis of the selected template.

9. The disposition optimization system according to claim 1, wherein
the disposition place is specified by a position on a two-dimensional area and a height in plural stages from the two-dimensional area; and
the plurality of mutual action emergence patterns indicates that a distance between the two disposition places on the two-dimensional area is equal to or smaller than a certain value, the distance is equal to or larger than the certain value, and the two disposition places are aligned in the height direction and the heights are different only by one stage.

10. The disposition optimization system according to claim 1, wherein
the plurality of mutual action emergence patterns indicate a distance between the two disposition places or the difference in a code which is a numeral value allocated to each of the two disposition places is equal to or smaller than a certain value, the distance or the difference in the code is equal to or larger than the certain value, the distance or the code is a specific value, each of the codes matches each other, and any two or more of logical products of the plurality of patterns in these patterns.

11. A disposition optimizing method of conducting analysis on disposition of a plurality of disposition targets, comprising steps of:
storing work achievement information indicating, for each work, the disposition target related to the work, an actual disposition place where the disposition target is disposed, and actual work time taken for the work for each work and storing location information indicating a plurality of disposition places capable of disposing the disposition targets;
acquiring a mutual action search policy including a plurality of mutual action emergence patterns indicating a relation between two of the disposition places influencing the work time taken for the work; and
generating a disposition plan indicating a plan of the disposition place where the disposition target is disposed on the basis of the work achievement information, the location information, and the mutual action search policy.

12. The disposition optimizing method according to claim 11, wherein
in generation of the disposition plan,
a location combination including, as representative disposition places, two of the disposition places applicable to each of the mutual action emergence pattern are extracted from the location information;
for each target combination which is a combination of predetermined two disposition targets included in the plurality of disposition targets, estimated work time estimating the work time when the two disposition targets included in the target combination are disposed at the representative disposition places corresponding to each mutual action emergence pattern is acquired; and
the disposition plan is generated on the basis of each of the estimated work time.

13. The disposition optimizing method according to claim 12, wherein
in generation of the disposition plan, a predetermined number of the target combination is selected in the order from a higher degree of improvement of the estimated work time from the actual work time, and the disposition plan is generated in which the disposition target included in the target combination is disposed at the disposition place where the improvement degree becomes the highest when the disposition target is disposed at each of the combination of the disposition places applicable to the mutual emergence pattern corresponding to the representative disposition place where the target combination is disposed for each of the selected target combinations.

14. The disposition optimizing method according to claim 12, wherein
the work achievement information further indicates a Work which is an operation unit for which the work is performed for each work; and
in generation of the disposition plan, the target combination is selected from the combinations of the disposition targets configured by the plurality of disposition targets on the basis of a number of times related to the work in the identical Work.

15. The disposition optimizing method according to claim 12, wherein
the mutual action search policy further includes a search importance degree which is an importance degree of the mutual action emergence pattern for each of the mutual action emergence patterns; and
in generation of the disposition plan, the location combinations are extracted in the number according to the search importance degree of the mutual action emergence pattern for each of the mutual action emergence patterns.
